(19) United States
(12) Patent Application Publication
(10) Pub. No.: US 2026/0180257 A1
(43) Pub. Date: Jun. 25, 2026

(54) CABLE APPARATUS AND METHOD

(71) Applicant: Samtec, Inc., New Albany, IN (US)

(72) Inventors: David S. Beraun, New Albany, IN (US); Sandeep Sankararaman, New Albany, IN (US)

(21) Appl. No.: 19/431,119

(22) Filed: Dec. 23, 2025

Related U.S. Application Data
(60) Provisional application No. 63/738,457, filed on Dec. 23, 2024.

(51) Int. Cl. H01R 13/6585

(52) U.S. Cl. CPC H01R 13/6585

(57) ABSTRACT

An electrical conductor as described and claimed herein. The electrical conductor may include a first electrical ground shield coupled to a second electrical ground. The second electrical ground may include one or more cantilevered fingers. The conductor may include one or more biasing mechanisms.

### TECHNICAL FIELD

The present embodiments relate generally to an electrical connector, with particular embodiments shown for a cable apparatus having ground and signal conductor(s) adapted to make contact with a substrate or component.

### BACKGROUND

Typical connectors have ground and signal conductors at the contact/first end to contact the component. However, tolerances, non-perpendicular alignment, and/or inconsistent distances may not allow adequate contact and/or pressure of one or more conductors against the component. Thus, there is a need for a connector configuration and/or conductor(s) to be consistently secured in contact and alignment with the component.

The present invention is directed at overcoming, or at least improving upon, the disadvantages of the prior art.

### BRIEF DESCRIPTION OF OTHER TECHNICAL FEATURES

U.S. Pat. Nos. 10,396,510; 9,692,191; and 9,645,172 and US Patent Publication 2022/0181826 are hereby incorporated by reference in their entireties.

### BRIEF DESCRIPTION OF THE ILLUSTRATIONS

In the drawings, like reference characters generally refer to the same parts throughout the different views. Also, the drawings are not necessarily to scale, emphasis instead generally being placed upon illustrating the principles of the invention.

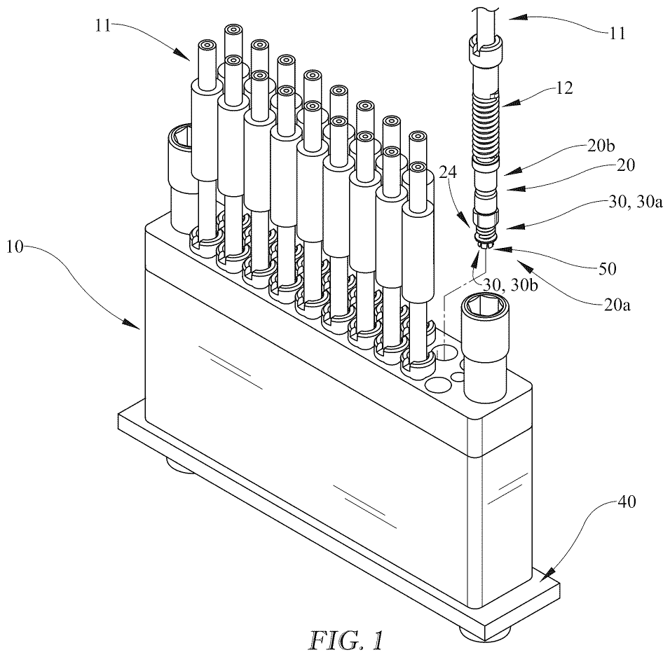

FIG. 1 is a perspective view of one embodiment of an electrical connector illustrating one embodiment of a contact element or electrical conductor exploded therefrom.

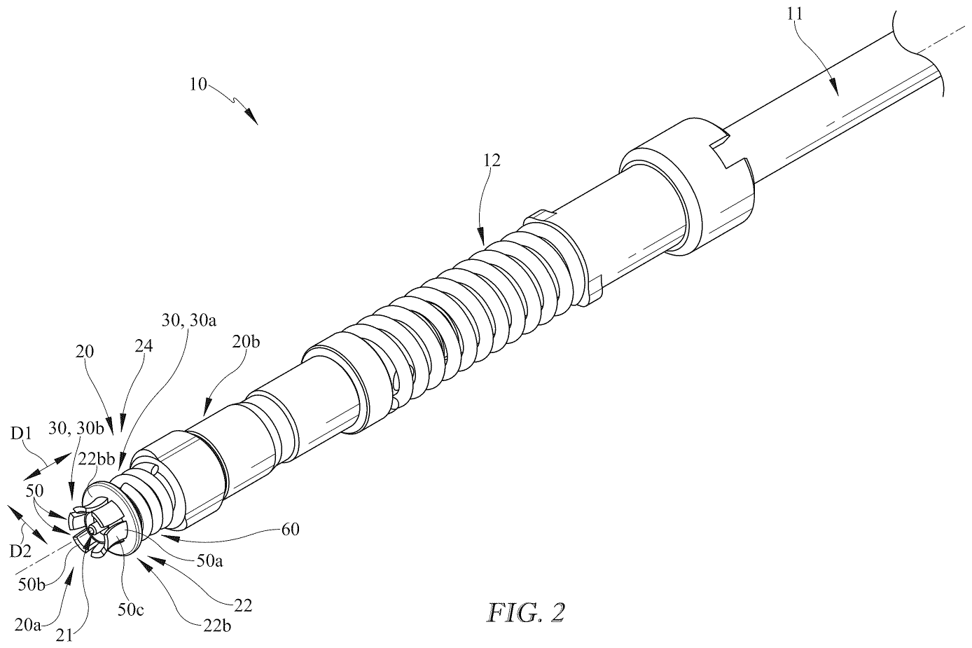

FIG. 2 is a perspective view of the electrical conductor of FIG. 1.

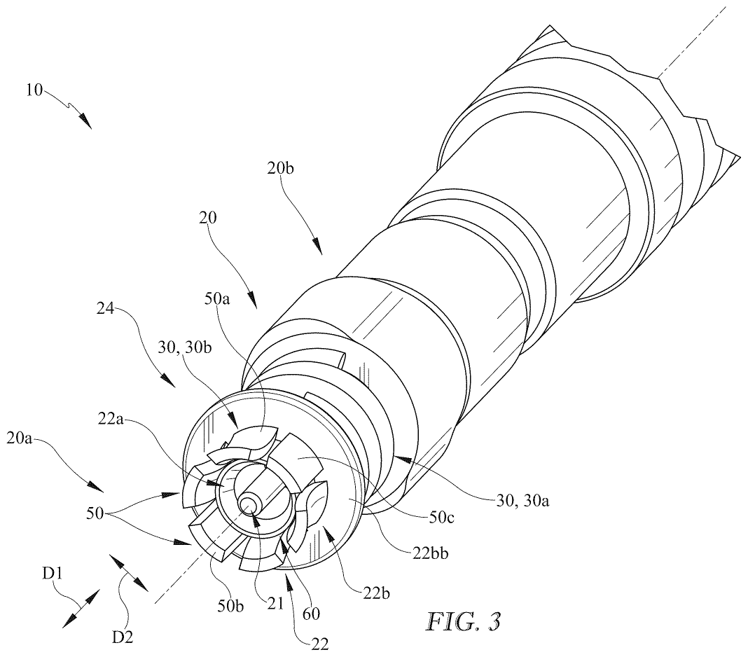

FIG. 3 is another perspective view of the electrical conductor of FIG. 2.

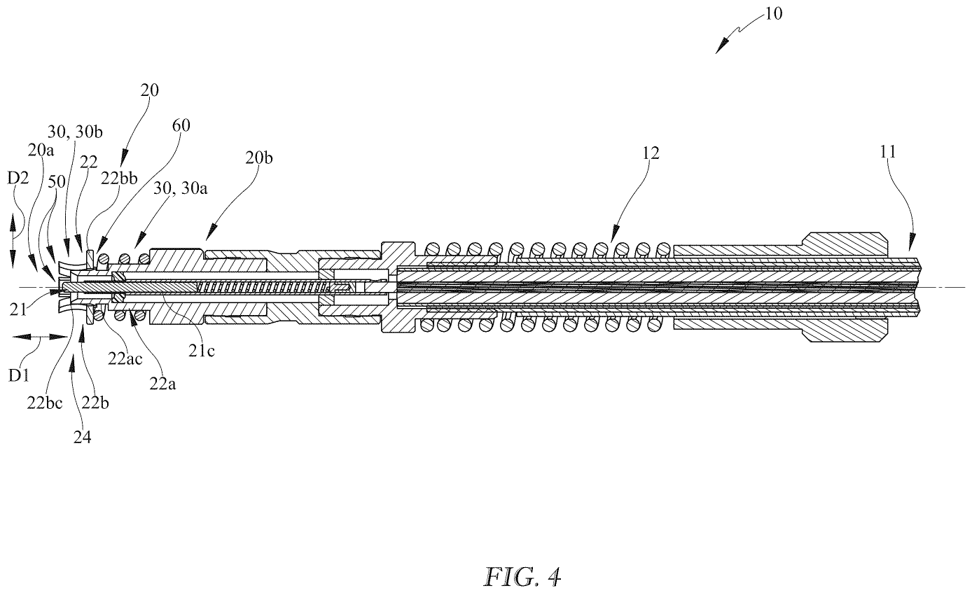

FIG. 4 is a sectional view of the electrical conductor of FIG. 2.

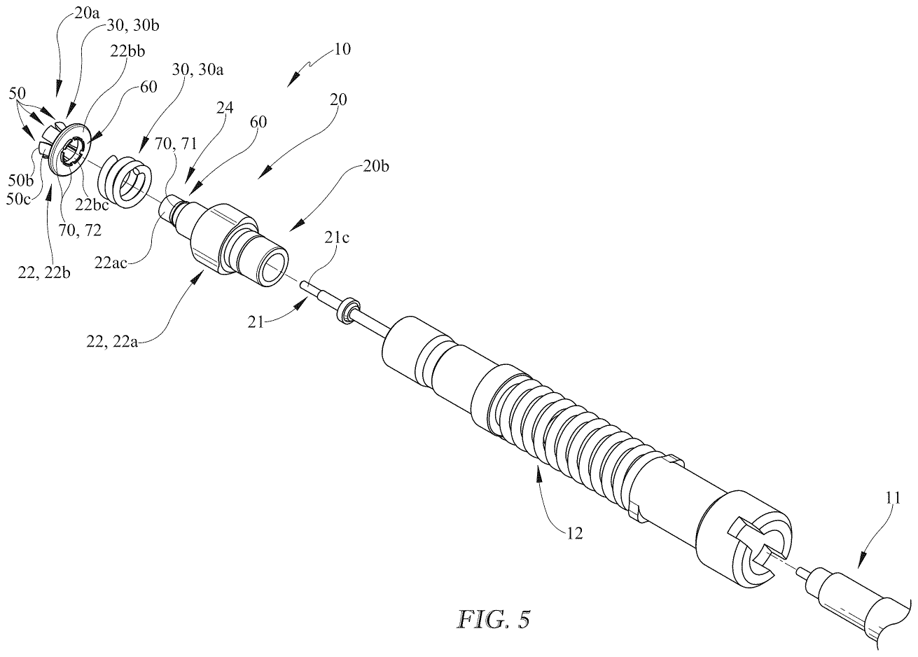

FIG. 5 is an exploded view of the electrical conductor of FIG. 2.

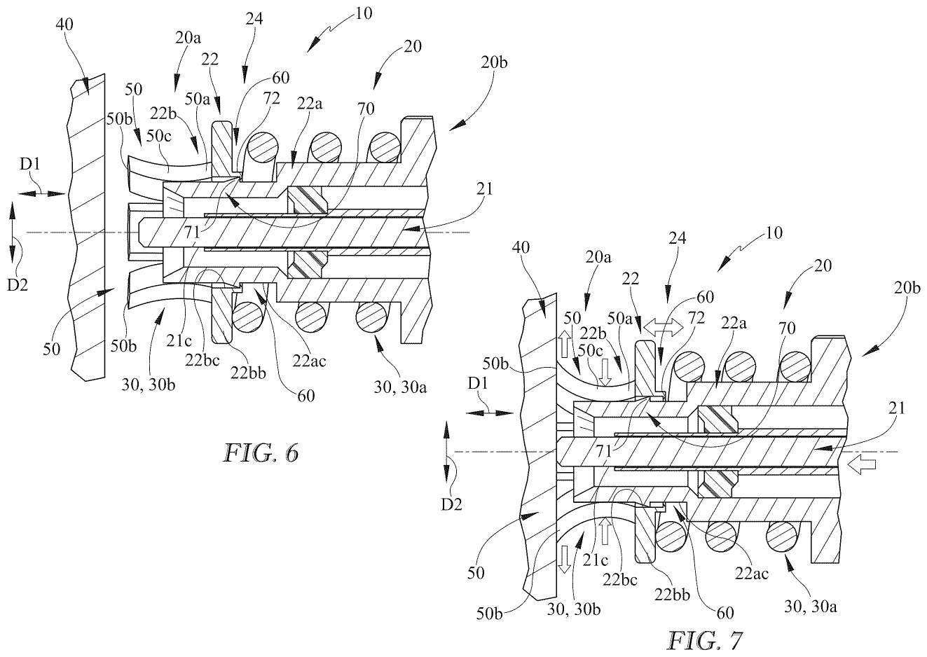

FIG. 6 is a sectional view of the first/contact end of the electrical conductor of FIG. 2 illustrating when the first end is not pressed against or contacting a mating surface or substrate; and

FIG. 7 is a sectional view of the first/contact end of the electrical conductor of FIG. 2 illustrating when the first end is pressed against or contacting a mating surface or substrate.

### DETAILED DESCRIPTION

Embodiments may further be understood with reference to the various Figures. With reference to the Figures, an embodiment provides for one or more electrical connectors 10. The electrical connector 10 may include one or more cables or electrical conductors 20. At least one electrical contact or conductor 20, or portions thereof, (e.g. first end 20a) may be a point of contact on a mating surface or substrate 40 (e.g. printed circuit board), or portions thereof as shown in FIGS. 1 and 7. One or more signals are to be transmitted between the conductor(s) 21, 22 of the electrical conductor 20 and the mating surface or substrate 40. The electrical conductor 20 may include a first end 20a and an opposed second end 20b.

In some implementations, the connector 10 and/or electrical conductor 20 may include a ground conductor/member/body 22 and a signal conductor/member/body 21. The ground member(s) 22 and signal member 21 are arranged at the contact or first end 20a of the electrical conductor 20. The signal member 21 may be a spring-loaded pin. The ground member 22 may include a first electrical ground/reference shield 22a and a second electrical ground/reference 22b. The ground member 22, first electrical ground shield 22a, and/or second electrical ground 22b is positioned adjacent the first end 20a of the electrical conductor 20. The signal conductor 21 is fully or at least partially surrounded by the first electrical ground shield 22a and/or second electrical ground 22b. The second electrical ground 22b (e.g. cantilever fingers 50) is physically connected (e.g. slidably), electrically connected, or both to the first electrical ground shield 22a. The ground member(s) 22 may include one or more sliding engagements 60 therebetween. The second electrical ground 22b, or portions thereof, may be in a sliding engagement with the first electrical ground shield 22a, or portions thereof.

In some implementations, the connector 10, electrical conductor 20, and/or ground 22 (e.g. second electrical ground 22b, first electrical ground shield 22a, both), or portions thereof, may include one or more biasing mechanisms 30. The second electrical ground 22b or ground member 22 may be spring-loaded with a biasing mechanism(s) 30 (e.g. first, second, etc.). The ground 22 or second electrical ground 22b may include a first biasing mechanism 30a. The first biasing mechanism 30a may bias/urge the second electrical ground 22b (e.g. cantilevered fingers 50) axially or longitudinally relative to the first electrical ground shield 22a (e.g. from the second end 20b towards the first end 20a). Although the first biasing mechanism is shown as a compression spring, other springs are contemplated such as, but is not limited to, a wave spring(s). The second electrical ground 22b may be biased/urged (e.g. by the first biasing mechanism 30a, continuously) in a direction D1 away from the second end 20b, towards the first end 20a, when the first end 20a is not pressed against a mating surface or substrate 40, when the first end 20a is pressed against the mating surface 40, or both. The ground 22, second electrical ground 22b, and/or cantilevered fingers 50 may include a second biasing mechanism 30b. The cantilever fingers 50 are spring-loaded or include the second biasing mechanism 30b. The second biasing mechanism 30b may bias/urge the second electrical ground 22b (e.g. cantilevered fingers 50) towards (e.g. radially, inwardly, both) the first electrical ground shield 22a or signal conductor 21. The second electrical ground 22b (e.g. cantilever fingers 50) may be biased radial inwards towards the signal conductor 21 or to contact (e.g. slidably) the first electrical ground shield 22a (e.g. outer periphery 22ac). The one or more cantilevered fingers 50 (e.g. distal free end 50b) and/or second electrical ground 22b may be biased/urged towards (e.g. radially, inwardly, both) the first electrical ground shield 22a when pressed, not pressed, or both against the mating surface or substate 40. Although the second biasing mechanism 30b is shown as resilient cantilevered fingers/protrusions 50, is should be understood that additional structures may be used such as, but is not limited to, one or more springs.

In some implementations, the connector 10, electrical conductor 20, and/or ground 22 (e.g. second electrical ground 22b, first electrical ground shield 22a, both), or portions thereof, may include one or more cantilevered fingers 50. The cantilevered fingers 50, if used, may be defined by the second electrical ground 22b or ground 22. The ground 22 (e.g. second electrical ground 22b), or portions thereof, may define at least one, at least two, at least three, at least four, and at least five cantilevered fingers. The cantilevered fingers 50 (e.g. middle portion 50c), or portions thereof, may be physically, electrically connected, or both to the first electrical ground shield 22a. Each cantilevered finger 50 may have a proximal end 50a and a distal free end 50b. Further, a middle portion 50c may interconnect the proximal end 50a and the distal free end 50b. The distal free end 50b may be adjacent or in the direction facing the first end 20a and the proximal end 50a may be adjacent or in the direction facing the second end 20b. The proximal end 50a may be adjacent or project from the flange 22bb. The cantilevered finger(s) 50 may be arcuate (e.g. longitudinally) in shape or cross-section. The cantilevered finger(s) 50 may form, in cross section, an arcuate shape that is convex in a direction D2 towards the outer surface or periphery 21c, 22ac of the signal conductor 21 and/or first electrical ground shield 22a, respectively, or the longitudinal axis. The distal free end(s) 50b may be flared outwardly away from the longitudinal axis of the electrical conductor 20 and/or signal conductor 21, and/or first electrical ground shield 22a. The proximal end(s) 50a may be flared outwardly away from the longitudinal axis of the electrical conductor 20 and/or signal conductor 21, and/or first electrical ground shield 22a. As shown more clearly in FIGS. 6 and 7, the proximal end 50a and distal free end 50b may be at a larger radius from the longitudinal axis of the electrical conductor 20 than the middle portion 50c. The cantilevered fingers 50 (e.g. distal free end 50b) flex (e.g. outwardly, radially, both) in a direction D2 away from the outer surface 21c, 22ac of the signal conductor 21 and/or first electrical ground shield 22a, respectively (e.g. when the first end 20a is pressed against the mating surface or substrate 40) and/or against the radial inwardly biasing (e.g. second biasing mechanism 30b) direction. The middle portion 50c of the cantilevered finger 50 may engage/contact (e.g. slidably, radially, inwardly) the first electrical ground shield 22a or outer periphery 22ac (e.g. when the first end 20a is pressed, not pressed, or both against the mating surface or substrate 40). In some embodiments as shown in FIG. 6, the proximal end 50a and distal free end 50b do not engage (e.g. physically) the first electrical ground shield 22a, or portions thereof. In some embodiments, a portion (e.g. middle portion 50c) of the cantilevered finger(s) 50 may deflect radially inward (e.g. in the direction D2) towards the first electrical ground shield 22a (e.g. outer periphery 22ac) (e.g. when the first end 20a is pressed, not pressed, or both against the mating surface or substrate 40). The middle portion 50c or finger 50 may deflect radially inward when the distal free end 50b is deflected radially outward, when the first end 20a is pressed against the substrate or mating surface 40. As shown in FIG. 7, this radial inward deflection of the finger 50 and/or middle portion 50c may increase radial compression against the first electrical ground shield 22a (e.g. outer periphery 22ac) when the distal free end 20b is pressed against the mating surface or substrate 40. As the outward deflection of the finger (e.g. distal free end 50b) increases, this may create more radial compression by the finger(s) (e.g. middle portion 50c), or portions thereof. The coupling means 24 of the second electrical ground 22b, first electrical ground 22a, and/or electrical conductor 20 may provide adequate contact with the substrate 40 and/or increase and/or decrease compression (e.g. radial) of the second electrical ground 22b with the first electrical ground shield 22a. The coupling means 24 may include the cantilever finger(s) 50, biasing mechanism(s) 30 (e.g. 30a, 30b, both), and/or sliding engagement 60.

In some implementations, the connector 10, electrical conductor 20, and/or ground 22 (e.g. second electrical ground 22b, first electrical ground shield 22a, both, cantilevered finger(s) 50), or portions thereof, may include one or more sliding engagements 60. The sliding engagement 60 may be between the second electrical ground 22b and the first electrical ground shield 22a. The inner periphery 22bc, or portions thereof, defining a through opening of the cantilevered fingers 50, flange 22bb, and/or retention member 70, of the second electrical ground 22b may slidably engage/receive/contact the outer periphery 22ac of the first electrical ground shield 22a, or portions thereof. The second electrical ground 22b (e.g. inner periphery 22bc, cantilevered finger(s) 50, middle portion 50c) slidably engages the first electrical ground shield 22a (e.g. outer periphery 22ac), between two or more sliding positions. The first electrical ground shield 22a may be stationary allowing the second electrical ground 22b (e.g. retention member 70, finger 50, middle portion 50c, inner periphery 22bc) to slide/move from a first sliding position (e.g. when the first end 20a is not pressed against the substrate, FIG. 6) to at least one second sliding position (e.g. when the first end 20a is pressed against the substrate, FIG. 7). Sliding of the second electrical ground 22b relative to the first electrical ground shield 22a may be along the longitudinal axis or direction D1 from the first end 20a to the second end 20b. In the first sliding position as shown in FIG. 6, the cantilevered fingers 50 (e.g. distal free end 50b) and the second electrical ground 22b are less deflected than when in the second sliding position shown in FIG. 7. Whereby the first and/or second biasing mechanisms 30a, 30b urge the finger(s) 50 and/or second electrical ground 22b to return (e.g. longitudinally, radially, both) to their home or less biased position more when in the second sliding position than when in the first sliding position. The second electrical ground 22b, retention member 70 (e.g. 72), and/or cantilevered finger(s) 50 (e.g. middle portion 50c) slide along or slidably engages the first electrical ground shield 22a, retention member 70 (e.g. 71), and/or outer periphery 22ac (e.g. between sliding positions).

In some implementations, the connector 10, electrical conductor 20, and/or ground 22 (e.g. second electrical ground 22b, first electrical ground shield 22a, both, cantilevered finger(s) 50), or portions thereof, may include one or more retention members 70. The retention members 70, if used, may retain/lock the second electrical ground 22b in engagement (e.g. longitudinal, sliding) with the first electrical ground shield 22a. The retention member(s) 70 may retain/lock the second electrical ground 22b from traveling/separating with the first electrical ground shield 22a, in a direction D1 from the second end 20b to the first end 20a. The retention member(s) 70 may be protrusion(s) from respective ground members 22a, 22b interfering with relative longitudinal/sliding travel relative to each other. The second electrical ground 22b may include one or more protrusions 72 projecting/extending radially inward from the inner periphery 22bc. A plurality of protrusions or annular ring of protrusions 72 may be circumferentially spaced about the inner periphery 22bc of the second electrical ground 22b as shown more clearly in FIG. 5. The first electrical ground shield 22a may include one or more protrusions 71 projecting/extending radially outward from the outer periphery 22ac. A single protrusion or annular ring 71 may be positioned on the outer periphery 22ac as shown more clearly in FIG. 5. The retention member(s) 70 may engage in the first sliding position as shown in FIG. 6. The retention member(s) 70 may be disengaged in the second sliding position as shown in FIG. 7. The retention member(s) 72 may be on the second end of the second electrical ground 22b, facing the second end 20b, and the cantilevered fingers 50 may be on the first end of the second electrical ground 22b, facing the first end 20a. A flange/body 22bb of the second electrical ground 22b may include the through opening defined by the inner periphery 22bc. The cantilevered finger(s) 50 may project in a first direction from the flange 22bb on or adjacent the first end of the ground member 22b and the retention members 70, 72 may project in the opposing second direction from the flange 22bb on or adjacent the second end of the ground member 22b. The first biasing mechanism 30a (e.g. spring) may engage/abut the flange 22bb of the ground member 22b. The first biasing mechanism 30a may be positioned between the flange 22bb and another or remaining portion of the electrical conductor 20 (e.g. second end 20b), biasing the second member 22b and/or flange 22bb towards the first end 20a. The spring or first biasing mechanism 30a may surround the retention members 72, 70, or portions thereof.

In use, in some implementations, contacting the electrical conductor 20 to the substrate 40 may include longitudinally biasing the second electrical ground 22b in a direction D1 from the second end 20b towards the first end 20a when the first end 20a is not pressed against the mating surface 40, pressed against the mating surface 40, or both. Contacting the electrical conductor 20 may include radially biasing (e.g. inwardly) the second electrical ground 22b and/or cantilevered fingers 50 towards the first electrical ground shield 22a and/or signal conductor 21, or portions thereof, when the first end 20a is not pressed against the mating surface 40, pressed against the mating surface 40, or both. In some embodiments, the contacting of the electrical conductor 20 may include sliding the second electrical ground 22b, retention member 70, 72, and/or cantilevered fingers 50 along the first electrical ground shield 22a or in the longitudinal direction D1. In some embodiments, the contacting of the electrical conductor 20 may include deflecting one or more cantilevered fingers 50 or the distal free end 50b in a direction D2 (e.g. radially, outwardly, both) away from the signal conductor 21, inner periphery 22bc, and/or first electrical ground shield 22a (e.g. outer periphery 22ac) when the first end 20a is pressed against the mating surface 40. In some embodiments, the contacting of the electrical conductor 20 may include slidably engaging the one or more cantilevered fingers 50 (e.g. middle portion 50c) against the outer periphery 22ac and/or the first electrical ground shield 22a when the first end 20a is not pressed against the mating surface 40, pressed against the mating surface 40, or both. In some embodiments, the contacting of the electrical conductor 20 may include increasing compression of the second electrical ground 22b, finger(s) 50, and/or middle portion 50c radially inwardly towards the first electrical ground shield 22a when the first end 20a is pressed against the mating surface or substrate 40. In some embodiments, the coupling means 24, the sliding engagement 60 (e.g. tolerances between the ground members inner/outer peripheries), biasing mechanism(s) 30 (e.g. first, second), retention member 70, and/or cantilevered finger(s) may allow the second electrical ground 22b to orientate perpendicular to and/or angled/transverse relative the longitudinal axis or direction D1 from the first end 20a to the second end 20b and/or substrate 40. Although the second electrical ground 22b is shown in the one embodiment to be perpendicular when pressed against the substrate 40, it should be understood that the second electrical ground 22b may be angled relative to the first electrical ground shield 22a or the longitudinal axis such that the second electrical ground 22b or first end 20a makes adequate contact upon uneven substrate 40 surfaces/contacts, or portions thereof, when pressed against the mating surface or substrate 40.

As shown in the Figures, the electrical conductor 20 and/or connector 10 may include the cable 11(e.g. coax). The cable 11 may be coupled (e.g. physically, electrically, both) to the electrical conductor 20 (e.g. second end 20b, ground 22, first electrical ground shield 22a, signal conductor 21), or portions thereof. An outer spring element 12 may be used in order to allow displacement of the electrical conductors 20 to the connector 10.

In some embodiments, an electrical conductor may include a first end and an opposed second end. In various embodiments, the electrical conductor may include a signal conductor fully or at least partially surrounded by a first electrical ground/reference shield. In some embodiments, the electrical conductor may include a spring-loaded second electrical ground/reference positioned adjacent to the first end.

In addition, in some embodiments, the spring-loaded second electrical ground/reference may define one or more of at least one, at least two, at least three, at least four, and at least five cantilevered fingers. In various embodiments, each of the cantilevered fingers may flex in a direction away from an outer surface of the signal conductor. In some embodiments, the spring-loaded second electrical ground/reference may be continuously biased in a direction away from the opposed second end even when the first end is not pressed against a mating surface or substrate. In various embodiments, the cantilevered fingers may be physically connected, electrically connected, or both to the first electrical ground/reference shield. In some embodiments, the cantilevered finger or fingers each form, in cross-section, an arcuate shape that is convex in a direction toward the outer surface of the signal conductor. In various embodiments, the spring-loaded second electrical ground/reference may be electrically connected to the first electrical ground/reference shield. In some embodiments, the first electrical ground/reference shield may be stationary and the second electrical ground/reference may move in a direction from the first end to the second end.

In some embodiments, an electrical conductor may include a first end and an opposed second end. In various embodiments, the electrical conductor may include a signal conductor surrounded by a first electrical ground shield adjacent the first end. In some embodiments, the electrical conductor may include a second electrical ground positioned adjacent to the first end and at least one of biased radially towards the first electrical ground shield and/or biased axially/longitudinally relative to the first electrical ground shield.

In addition, in some embodiments, the second electrical ground may be biased radially towards the first electrical ground shield. In various embodiments, the second electrical ground may be biased axially/longitudinally relative to the first electrical ground shield. In some embodiments, the second electrical ground slidably engages the first electrical ground shield. In various embodiments, the second electrical ground may define one or more cantilevered fingers. In some embodiments, the one or more cantilevered fingers may be biased radially towards the first electrical ground shield. In various embodiments, the one or more cantilevered fingers may slidably engage the first electrical ground shield. In some embodiments, the one or more cantilevered fingers may include a proximal end and a distal free end. In various embodiments, a portion between the proximal end and the distal free end engages the first electrical ground shield. In some embodiments, the one or more cantilevered fingers may be longitudinally arcuate in cross-section. In various embodiments, the one or more cantilevered fingers may increase radial compression against the first electrical ground shield when the first end is pressed against a mating surface or substrate. In some embodiments, the second electrical ground may include a biasing mechanism longitudinally biasing the second electrical ground towards the first end away from the second end. In various embodiments, the second electrical ground may include one or more retention members locking the second electrical ground in longitudinal engagement with the first electrical ground shield. In some embodiments, the electrical conductor may be in combination with a connector.

In some embodiments, a connector may include one or more electrical conductors. In various embodiments, each of the one or more electrical conductors may have a first end and an opposed second end, a signal conductor fully or at least partially surrounded by a first electrical ground/reference shield, and/or a spring-loaded second electrical ground/reference positioned adjacent to the first end.

In some embodiments, an electrical conductor may include a first end and an opposed second end. In various embodiments, the electrical conductor may include a signal conductor surrounded by a first electrical ground shield adjacent the first end. In some embodiments, the electrical conductor may include a second electrical ground positioned adjacent to the first end. In various embodiments, the second electrical ground may slidingly engage an outer periphery of the first electrical ground shield.

In addition, in some embodiments, the second electrical ground may include one or more retention members. In various embodiments, the one or more retention members may be at least one protrusion extend inwardly from an inner periphery of the second electrical ground locking the second electrical ground in longitudinal engagement with the first electrical ground shield. In some embodiments, the second electrical ground may include one or more cantilevered fingers slidably engaging an outer periphery of the second electrical ground. In various embodiments, the one or more cantilevered fingers may include a distal free end and a proximal end. In some embodiments, a portion between the distal free end and the proximal end slidably engages the outer periphery of the second electrical ground. In some embodiments, the second electrical ground may be spring-loaded in a direction from the second end towards the first end.

In some embodiments, an electrical conductor may include a first end and an opposed second end. In various embodiments, the electrical conductor may include a signal conductor surrounded by a first electrical ground shield adjacent the first end. In some embodiments, the electrical conductor may include a second electrical ground positioned adjacent to the first end. In various embodiments, the second electrical ground may include one or more cantilevered fingers deflecting radially outward away from the first electrical ground shield when the first end is pressed against a mating surface or substrate.

In addition, in some embodiments, a portion of the one or more cantilevered fingers may deflect radially inward towards the first electrical ground shield when the first end is pressed against a mating surface or substrate. In various embodiments, the second electrical ground may be spring-loaded in a direction from the second end towards the first end.

In some embodiments, a method of contacting an electrical conductor to a substrate or mating surface may include providing an electrical conductor having a first end and an opposed second end, a signal conductor surrounded by a first electrical ground shield adjacent the first end, and/or a second electrical ground positioned adjacent to the first end. In various embodiments, the method may include longitudinally biasing the second electrical ground in a direction from the second end towards the first end when the first end is not pressed against a mating surface or substrate. In some embodiments, the method may include radially biasing the second electrical ground radially inward towards the first electrical ground shield. In various embodiments, the method may include sliding the second electrical ground along the direction. In some embodiments, the method may include increasing compression of the second electrical ground radially inwardly towards the first electrical ground shield when the first end is pressed against a mating surface or substrate. In some embodiments, the second electrical ground may include one or more cantilevered fingers. In various embodiments, the method may include deflecting the one or more cantilevered fingers in a direction away from an outer periphery of the signal conductor. In some embodiments, the method may include slidably engaging the one or more cantilevered fingers against an outer periphery of the first electrical ground shield.

In some embodiments, an electrical conductor may include a first end and an opposed second end. In various embodiments, the electrical conductor may include a signal conductor fully or at least partially surrounded by a first electrical ground/reference shield. In some embodiments, the electrical conductor may include a spring-loaded second electrical ground/reference positioned adjacent to the first end. In various embodiments, the second electrical ground may include a coupling means to increase radial compression with the first electrical ground shield.

In addition, in some embodiments, the coupling means may include one or more cantilevered fingers. In various embodiments, the coupling means may include a sliding engagement between the first electrical ground shield and the second electrical ground. In some embodiments, the radial compression may be inwardly towards the first electrical ground shield.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,”“holding,”“composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. An electrical conductor comprising:
a first end and an opposed second end;
a signal conductor fully or at least partially surrounded by a first electrical ground/reference shield; and
a spring-loaded second electrical ground/reference positioned adjacent to the first end.

2. The electrical conductor of claim 1 wherein the spring-loaded second electrical ground/reference defines one or more of at least one, at least two, at least three, at least four, and at least five cantilevered fingers.

3. The electrical conductor of claim 2 wherein each of the cantilevered fingers flexes in a direction away from an outer surface of the signal conductor.

4. The electrical conductor of claim 1 wherein the spring-loaded second electrical ground/reference is continuously biased in a direction away from the opposed second end even when the first end is not pressed against a mating surface or substrate.

5. The electrical conductor of claim 2 wherein the cantilevered fingers are physically connected, electrically connected, or both to the first electrical ground/reference shield.

6. The electrical conductor of claim 3 wherein the cantilevered finger or fingers each form, in cross-section, an arcuate shape that is convex in a direction toward the outer surface of the signal conductor.

7. The electrical conductor of claim 1 wherein the spring-loaded second electrical ground/reference is electrically connected to the first electrical ground/reference shield.

8. The electrical conductor of claim 1 wherein the first electrical ground/reference shield is stationary and the second electrical ground/reference moves in a direction from the first end to the second end.

9. An electrical conductor comprising:
a first end and an opposed second end;
a signal conductor surrounded by a first electrical ground shield adjacent the first end; and
a second electrical ground positioned adjacent to the first end and at least one of biased radially towards the first electrical ground shield and/or biased axially/longitudinally relative to the first electrical ground shield.

10. The electrical conductor of claim 9 wherein the second electrical ground is biased radially towards the first electrical ground shield.

11. The electrical conductor of claim 9 wherein the second electrical ground is biased axially/longitudinally relative to the first electrical ground shield.

12. The electrical conductor of claim 9 wherein the second electrical ground slidably engages the first electrical ground shield.

13. The electrical conductor of claim 9 wherein the second electrical ground defines one or more cantilevered fingers, and wherein the one or more cantilevered fingers are biased radially towards the first electrical ground shield.

14. The electrical conductor of claim 13 wherein the one or more cantilevered fingers slidably engage the first electrical ground shield.

15. The electrical conductor of claim 13 wherein the one or more cantilevered fingers include a proximal end and a distal free end, and wherein a portion between the proximal end and the distal free end engages the first electrical ground shield.

16. The electrical conductor of claim 13 wherein the one or more cantilevered fingers are longitudinally arcuate in cross-section.

17. The electrical conductor of claim 13 wherein the one or more cantilevered fingers increase radial compression against the first electrical ground shield when the first end is pressed against a mating surface or substrate.

18. The electrical conductor of claim 9 wherein the second electrical ground includes a biasing mechanism longitudinally biasing the second electrical ground towards the first end away from the second end.

19. The electrical conductor of claim 9 wherein the second electrical ground includes one or more retention members locking the second electrical ground in longitudinal engagement with the first electrical ground shield.

20. (canceled)

21. A connector comprising:
one or more electrical conductors; and
wherein each of the one or more electrical conductors having a first end and an opposed second end, a signal conductor fully or at least partially surrounded by a first electrical ground/reference shield, and a spring-loaded second electrical ground/reference positioned adjacent to the first end.

22.-39. (canceled)
